(19) United States
(12) Patent Application Publication
(10) Pub. No.: US 2024/0023000 A1
(43) Pub. Date: Jan. 18, 2024

(54) Preventing the Use of a Wireless Terminal in a Proscribed Area

(71) Applicant: Polaris Wireless, Inc., Santa Clara, CA (US)

(72) Inventors: Robert Lewis Martin, Antioch, CA (US); Mahesh B Patel, Saratoga, CA (US); Aamir Abdul Sattar, Mountain View, CA (US)

(73) Assignee: Polaris Wireless, Inc., Santa Clara, CA (US)

(21) Appl. No.: 18/129,869

(22) Filed: Apr. 2, 2023

Related U.S. Application Data
(60) Provisional application No. 63/389,886, filed on Jul. 16, 2022.

(51) Int. Cl. H04W 48/04; H04W 48/16

(52) U.S. Cl. CPC H04W 48/04; H04W 48/16

(57) ABSTRACT

A wireless telecommunication system is described that denies wireless telecommunication service to a wireless terminal in a proscribed area (e.g., prison, military installation, academic testing center, school, etc.). The system comprises an adjunct called a “service sentry.” The service sentry uses measurements of the location-dependent traits of the radio signals transmitted to, and received from, each wireless terminal in its purview to generate an estimate of the location of the wireless terminal. When the service sentry estimates that the wireless terminal has entered the proscribed area, it requests that the wireless switching center that services the proscribed area deny service to the wireless terminal. When the service sentry estimates that the wireless terminal has exited the proscribed area, it requests that the wireless switching center that services the proscribed area provide service to the wireless terminal.

### CROSS-REFERENCE TO RELATED APPLICATIONS

This application claims the benefit of U.S. Patent Application Ser. No. 63/389,886, filed 2022 Jul. 16, entitled “Preventing the Use of a Wireless Terminal in a Proscribed Area,” (Attorney Docket 0465-490pr1), which is incorporated by reference. To the extent that there are inconsistencies in language or ideas between the ′886 provisional application and this application, the language and ideas in this application are to prevail in the construction of this application.

U.S. patent application Ser. No. 17/390,815, filed 2021 Jul. 30, entitled “Preventing the Use of a Wireless Terminal in a Proscribed Area,” (Attorney Docket 0465-480 us1) is incorporated by reference. To the extent that there are inconsistencies in language or ideas between the ′815 non-provisional application and this application, the language and ideas in this application are to prevail in the construction of this application.

### FIELD OF THE INVENTION

The present invention relates to wireless telecommunications in general and, more particularly, to a system and method for preventing the use of a wireless terminal in a proscribed area.

### BACKGROUND OF THE INVENTION

In general, society benefits when everyone has access to wireless telecommunications service. There are, however, exceptions. For example, there are good reasons why inmates in prison and students in academic testing centers are prohibited from using wireless terminals.

There are two well-known solutions in the prior art for preventing the use of a wireless terminal in a proscribed area:
jammers, and
IMSI-catchers.

FIG. 1 depicts a schematic diagram of the salient components of a wireless telecommunications system in which a jammer prevents the use of a wireless terminals in a proscribed area.

Wireless telecommunications system 100 comprises: wireless terminal 101, cellular base stations 102-1, 102-2, and 102-3, cellular signal jammer 103, wireless switching center 111, service area 120, and proscribed area 121, interrelated as shown. The purpose of wireless telecommunication system 100 is to provide wireless telecommunications service to those wireless terminals in service area 120, and the purpose of jammer 103 is to interfere with the ability of wireless telecommunication system 100 to provide wireless telecommunications service to those wireless terminals in proscribed area 121.

Cellular signal jammer 103 is placed inside of proscribed area 121 where it radiates one or more signals that electromagnetically interfere with or “jam” the radio signals that wireless terminal 101 uses to communicate with cellular base stations 102-1, 102-2, and 102-3. The jammer does not prevent the user of wireless terminal 101 from possessing the terminal, but it prevents wireless terminal 101 from being able to communicate.

A jammer has advantages and disadvantages. A jammer is advantageous in that it is effective, it is inexpensive, and its effect is geographically limited to the range of the jamming signal so that when a wireless terminal exits the proscribed area it is able to communicate.

A jammer is disadvantageous, however, in that it is a tangible electronic device that must be physically located inside of, or very near to, the proscribed area, which makes it vulnerable to vandalism by anyone who objects to its existence. Furthermore, a jammer is also disadvantageous in that it denies service to all of the wireless terminals in its purview, and it cannot discriminate and permit the use of wireless terminals by authorized people (e.g., prison guards, teachers, etc.) while concurrently prohibiting the use of wireless terminals by unauthorized people (e.g., prisoners, students, etc.).

It is well known in the prior art how to use a jammer to prevent the use of a wireless terminal in a proscribed area.

FIG. 2 depicts a schematic diagram of the salient components of a wireless telecommunications system in which an IMSI-catcher prevents the use of a wireless terminals in a proscribed area.

Wireless telecommunications system 200 comprises: wireless terminal 201, cellular base stations 202-1, 202-2, and 202-3, IMSI-catcher 203, wireless switching center 211, service area 220, and proscribed area 221, interrelated as shown. The purpose of wireless telecommunications system 200 is to provide wireless telecommunications service to the wireless terminals within service area 220, and the purpose of IMSI-catcher 203 is to enable a human operator to locate and confiscate all of the unauthorized wireless terminals in proscribed area 221.

An IMSI-catcher has advantages and disadvantages. An IMSI-catcher is advantageous in that it enables the operator of the IMSI-catcher to discriminate between authorized and unauthorized wireless terminals, and, therefore, to confiscate the only unauthorized ones while allowing the authorized ones to remain and operate normally.

An IMSI-catcher is disadvantageous in that it requires a human operator who is honest and conscientious and impervious to influence or bribery. Experience has shown, however, that too many operators—especially those working in prisons—can be compromised.

It is well known in the prior art how to make and use an IMSI-catcher to prevent the use of a wireless terminal in a proscribed area.

### SUMMARY OF THE INVENTION

The present invention prevents the use of a wireless terminal in a proscribed area without some of the costs and disadvantages for doing so in the prior art. In particular, the illustrative embodiment of the present invention:
(i) provides service to each wireless terminal that is:
   (a) inside of the telecommunications system's service area, and
   (b) outside of a proscribed area that is within the service area; and
(ii) provides service to each wireless terminal that is:
   (a) inside of the proscribed area, and
   (b) is authorized to receive service within the proscribed area; and
(iii) denies service to each wireless terminal that is:
   (a) inside of the proscribed area, and
   (b) not authorized to receive service within the proscribed area.

To accomplish this, the illustrative embodiment comprises:
(i) a wireless telecommunications system that is capable of providing wireless telecommunications service to the wireless terminals in a service area, and
(ii) a wireless switching center that can selectively provide or deny service to each wireless terminal in response to a request to do so, and
(iii) an adjunct to the wireless switching center called a “service sentry.”

The service sentry is responsible for:
(i) knowing the spatial boundaries of the proscribed area, and
(ii) maintaining a list of the wireless terminals that are authorized to receive service in the proscribed area, and
(iii) continually estimating whether each wireless terminal in the service area is also inside of the proscribed area, and
(iv) requesting the wireless switching center to deny service to those unauthorized wireless terminals that are estimated to be inside of the proscribed area, and
(v) requesting the wireless switching center to discontinue denying (i.e., restore) service to those unauthorized wireless terminals that are estimated to have exited the proscribed area.

To accomplish this, the service sentry continually generates a pair of estimates for each wireless terminal:
(i) an estimate of whether the wireless terminal is inside of the proscribed area, and
(ii) an estimate of the service sentry's confidence that its ‘estimate of whether wireless terminal is inside of the proscribed area’ is correct.
   After each pair of estimates is generated for a wireless terminal, the service sentry considers two actions.

First, when the pair of estimates for a wireless terminal indicates that:
(i) the wireless terminal is inside of the proscribed area, and
(ii) the estimate of the confidence exceeds a first threshold value X, and
(iii) the wireless terminal is not currently being denied service, and
(iv) the wireless terminal is not authorized to operate in the proscribed area, then the service sentry sends a request to the wireless switching center to deny service to the wireless terminal.

Second, when the pair of estimates for a wireless terminal indicates that:
(i) the wireless terminal is not inside (i.e., outside) of the proscribed area, and
(ii) the estimate of the confidence exceeds a second threshold value Y, and
(iii) the wireless terminal is currently being denied service, then the service sentry sends a request to the wireless switching center to discontinue denying (i.e., restore) service to the wireless terminal.

The purpose of having the service sentry continually re-generate new pairs of estimates is to enable it to quickly identify and address:
(i) the movement of unauthorized wireless terminals into the proscribed area, and
(ii) the appearance of unauthorized wireless terminals in the proscribed area, and
(iii) the movement of wireless terminals out of the proscribed area.

In accordance with the illustrative embodiment, the rate at which the service sentry makes new pairs of estimates is a function of how close the wireless terminal is to the proscribed area. When the wireless terminal is closer to the proscribed area, the rate of generating new estimates increases. When the wireless terminal is farther from the proscribed area and when the wireless terminal is inside of the proscribed area the rate of generating new estimates decreases. The reason is that it is computationally expensive for the service sentry to generate pairs of estimates, and, therefore, the service sentry conserves resources when it is reasonable to do so.

The estimate of whether a wireless terminal is inside of the proscribed area can be wrong, and it is most likely to be wrong when the wireless terminal is on the periphery of the proscribed area. When the wireless terminal is on the periphery of the proscribed area, it is possible that estimates will vacillate between “inside” and “outside,” regardless of whether the wireless terminal actually moves or not. Without more, this vacillation could cause the illustrative embodiment to thrash between denying and restoring service. Such thrashing is not only a waste of computational resources, it is annoying to the user of the wireless terminal.

To reduce the likelihood of thrashing, the service sentry only sends requests to deny or restore service when the service sentry is highly confident that the estimate of whether the wireless terminal is inside of the proscribed area is correct.

To ensure this, the illustrative embodiment generates an estimate of the confidence it has that its own estimate that the wireless terminal is, in fact, inside of the proscribed area. Once the estimate of confidence is made, the service sentry only sends requests to deny or restore service when the estimate of confidence exceeds a threshold value.

The estimate of whether the wireless terminal is inside of the proscribed area can be wrong in two fundamentally different ways:
(i) The service sentry can estimate that the wireless terminal is outside of the proscribed area when, in fact, it is inside of the proscribed area. In this case, the wireless terminal is incorrectly provided service.
(ii) The service sentry can estimate that the wireless terminal is inside of the proscribed area when, in fact, it is outside of the proscribed area. In this case, the wireless terminal is incorrectly denied service.
   In general, the first kind of error is considered more problematic than the second. To ensure that the first kind of error is less likely to occur than the second kind of error, the illustrative embodiment uses two different confidence thresholds for denying and restoring service, respectively, and the confidence threshold for restoring service is higher than the confidence threshold for denying service.

For each wireless terminal that the wireless switching center serves, the service sentry can generate the pair of estimates based solely on the empirical evidence that is available to it from the wireless switching center (e.g., the reported signal-strength measurements by the wireless terminal of the base stations in the wireless terminal's list of neighboring base stations, etc.).

The illustrative embodiment, however, comprises a mechanism to augment the evidence available to the wireless switching center with evidence gathered by the wireless terminal itself. In general, the evidence gathered by the wireless terminal is likely to be highly reliable and probative.

In accordance with the illustrative embodiment, any user of a wireless terminal who lives, works, or merely travels near the proscribed area can elect to add software (e.g., an “app,” etc.) to their wireless terminal, which software assists the service sentry in estimating whether the wireless terminal is inside of the proscribed area. This is particularly beneficial to the user because it substantially reduces the likelihood that the illustrative embodiment will (erroneously) deny service to a wireless terminal that is outside of the proscribed area.

The software directs the wireless terminal to continually collect empirical evidence of its location. In accordance with the illustrative embodiment, the empirical evidence includes:
(i) measurements of the location-dependent traits of the electromagnetic signals transmitted by the cellular base stations in the vicinity of the wireless terminal, and
(ii) the identity of the wireless local area networks (e.g., 802.11 WiFi networks, etc.) in the vicinity of the wireless terminal, and
(iii) one or more ranging signals from satellite-positioning system (e.g., GPS, GLONASS, etc.) satellites.

The software includes a definition of the proscribed area and directs the wireless terminal to generate (based on the empirical evidence it gathered):
(i) its own estimate of whether wireless terminal is inside of the proscribed area, and
(ii) its own estimate of the confidence that its ‘estimate of whether wireless terminal is inside of the proscribed area’ is correct.
   The wireless terminal then transmits these estimates to the service sentry.

In accordance with the illustrative embodiment, the wireless terminal does not transmit to the service sentry:
(i) the raw empirical evidence of its location, or
(ii) the wireless terminal's estimate of its own location so as to protect the privacy of the user of the wireless terminal.

The service sentry receives the estimates from the wireless terminal and generates:
(i) its own estimate of whether wireless terminal is inside of the proscribed area, and
(ii) its own estimate of the confidence in the estimate of whether wireless terminal is inside of the proscribed area is correct.

The service sentry can simply adopt the wireless terminal's estimates for as its own, or it can combine them with the empirical evidence from the wireless switching center, but in either case the inclusion of the data from the wireless terminal is likely to make the estimates be more reliable than without it.

The service sentry uses different methods for requesting the denial and restoration of service for wireless terminals that are “native” (i.e., not roaming and whose home is the wireless switching center) than for those that are “not native” (i.e., roaming and whose home is not the wireless switching center). For wireless terminals that are native to the wireless switching center, the service sentry transmits a request to the operator determined barring module in the wireless switching center asking that the wireless terminal be “blocked” or “un-blocked,” as appropriate. In contrast, for wireless terminals that are not-native to the wireless switching center, the service sentry transmits a request to the equipment identity register in the wireless switching center asking that the wireless terminal be “blacklisted” or “un-blacklisted,” as appropriate.

The illustrative embodiment comprises: transmitting, to a wireless terminal, a definition of a proscribed area, wherein: (i) the wireless terminal is a native user of a wireless switching center, and (ii) the wireless terminal is being provided telecommunications service by a wireless telecommunications system that comprises the wireless switching center; receiving, from the wireless terminal, a first estimate of whether the wireless terminal is inside of the proscribed area at a first time; and transmitting, to an operator determined barring module associated with the wireless switching center, a request to block service to the wireless terminal when the first estimate is that the wireless terminal is inside of the proscribed area.

### BRIEF DESCRIPTION OF THE DRAWINGS

FIG. 1 depicts a schematic diagram of the salient components of a first wireless telecommunications system in the prior art.

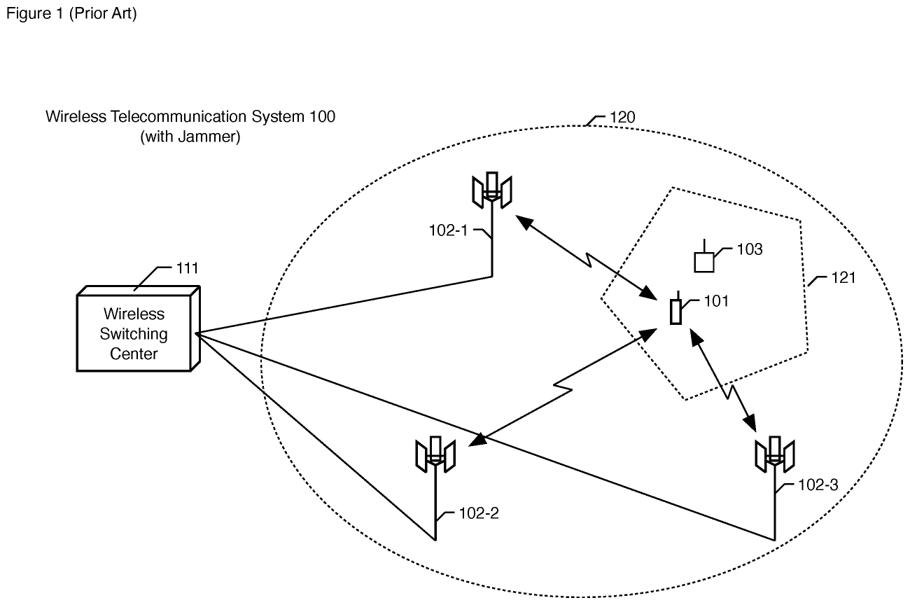

FIG. 2 depicts a schematic diagram of the salient components of a second wireless telecommunications system in the prior art.

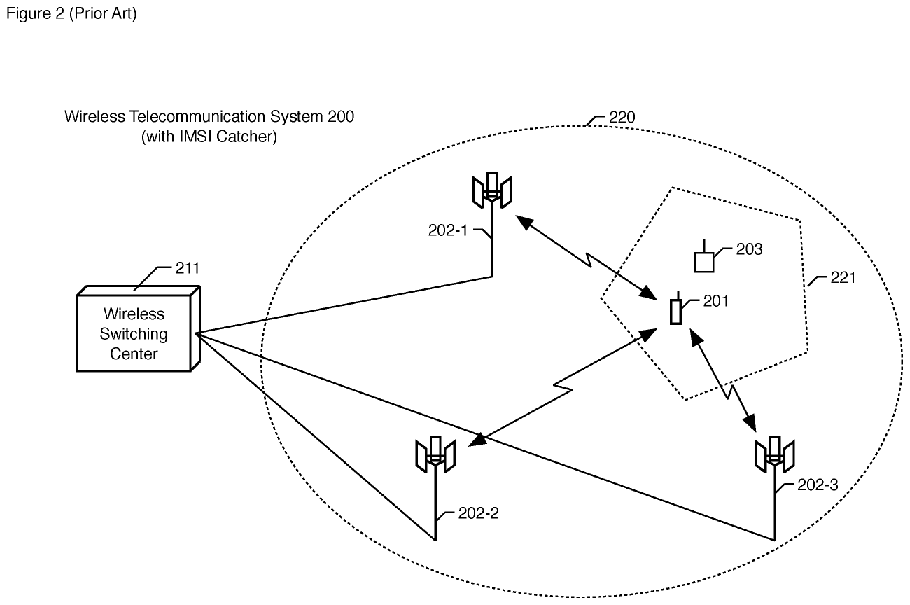

FIG. 3 depicts a diagram of the salient components of a wireless telecommunications system in accordance with the illustrative embodiment of the present invention.

FIG. 4 depicts a schematic diagram of the salient components of wireless switching center 311, which orchestrates the operation of wireless telecommunications system 300.

FIG. 5 depicts the salient components of service sentry 312.

FIG. 6 depicts a schematic diagram of the salient components of wireless terminal 301-j.

FIG. 7 depicts a flowchart of the operation of the illustrative embodiment of the present invention as performed by service sentry 312.

FIG. 8 depicts a flowchart of the salient subtasks associated with the performance of task 706.

FIG. 9 depicts a flowchart of the salient subtasks associated with the performance of task 707.

FIG. 10 depicts a flowchart of the salient tasks performed by wireless terminal 301-j in accordance with the illustrative embodiment.

### DEFINITIONS

Based on—For the purposes of this specification, the phrase “based on” is defined as “being dependent on” in contrast to “being independent of”. The value of Y is dependent on the value of X when the value of Y is different for two or more values of X. The value of Y is independent of the value of X when the value of Y is the same for all values of X. Being “based on” includes both functions and relations.

Generate—For the purposes of this specification, the infinitive “to generate” and its inflected forms (e.g., “generating”, “generation”, etc.) should be given the ordinary and customary meaning that the terms would have to a person of ordinary skill in the art at the time of the invention.

Identity of a Radio Signal—For the purposes of this specification, the phrase “identity of a radio signal” is defined as one or more indicia that distinguish one radio signal from another radio signal.

Location—For the purposes of this specification, the term “location” is defined as a zero-dimensional point, a finite one-dimensional path segment, a finite two-dimensional surface area, or a finite three-dimensional volume.

Location-Dependent Information—For the purposes of this specification, the term “location-dependent information” is defined as information that varies with location. For example and without limitation location-dependent information can be:
(i) a measurement of a location-dependent trait (e.g., signal strength, etc.) of a radio signal as received by the wireless terminal,
(ii) the identity of a radio signal as received by the wireless terminal (e.g., in a service environment in which different radio signals transmitted from different locations are assigned different identities, etc.), or
(iii) the identity (e.g., service set identifier [SSID], media access control [MAC] address, etc.) of the base station in communication with the wireless terminal (e.g., in a service environment in which different base stations at different locations are assigned different identities, etc.).

Location-Dependent Trait of a Radio Signal—For the purposes of this specification, the term “location-dependent trait of a radio signal” is defined as a characteristic of a radio signal that varies with:
(i) the location of the transmitter of the signal, or
(ii) the location of the receiver of the signal, or
(iii) both i and ii.
   For example and without limitation the amplitude and phase of a radio signal are generally location-dependent traits of the signal. In contrast, the frequency of a given radio signal is generally not a location-dependent trait of the signal.

Location-Trait Database—For the purposes of this specification, a “Location-Trait Database” is defined as a mapping that associates:
(i) one or more location-dependent traits of one or more radio signals received or transmitted by a wireless terminal, or
(ii) the identity of one or more radio signals received or transmitted by a wireless terminal, or
(iii) both i and ii, at each of a plurality of locations.

Native—For the purposes of this specification, a wireless terminal is “native” to a wireless switching center when the wireless terminal is not roaming to the wireless switching center (e.g., the wireless terminal is listed in the Home Location Register of the wireless switching center, etc.).

Non-Native—For the purposes of this specification, a wireless terminal is “non-native” to a wireless switching center when the wireless terminal is roaming to the wireless switching center (e.g., the wireless terminal is listed in the Visitor Location Register of the wireless switching center, etc.).

Processor—For the purposes of this specification, a “processor” is defined as hardware or hardware and software that performs mathematical and/or logical operations.

Power—For the purposes of this specification, the “power” of a radio signal is defined as the locally-averaged signal strength of the radio signal.

Radio—For the purposes of this specification, a “radio” is defined as hardware or hardware and software that is capable of telecommunications via an unguided (i.e., wireless) radio signal of frequency less than 600 GHz.

Radio-Frequency Environment—For the purposes of this specification the term “radio-frequency environment” is defined as a quantitative characterization of the nature and location of the radio-frequency obstacles in the vicinity of the reference radio, the wireless terminal, and the signal path between the reference radio and the wireless terminal.

Reasonable Estimate—For the purposes of this specification, the term “reasonable estimate” and its inflected forms is defined as an estimate that is based on empirical evidence and logic. A reasonable estimate is not necessarily correct, but it is not a blind guess.

Receive—For the purposes of this specification, the infinitive “to receive” and its inflected forms (e.g., “receiving”, “received”, etc.) should be given the ordinary and customary meaning that the terms would have to a person of ordinary skill in the art at the time of the invention.

Transmit—For the purposes of this specification, the infinitive “to transmit” and its inflected forms (e.g., “transmitting”, “transmitted”, etc.) should be given the ordinary and customary meaning that the terms would have to a person of ordinary skill in the art at the time of the invention.

Wireless Terminal—For the purposes of this specification, the term “wireless terminal” is defined as a tangible device that is capable of telecommunications without a wire or tangible transmission medium. A wireless terminal can be mobile or immobile. A wireless terminal can transmit or receive or transmit and receive.

### DETAILED DESCRIPTION

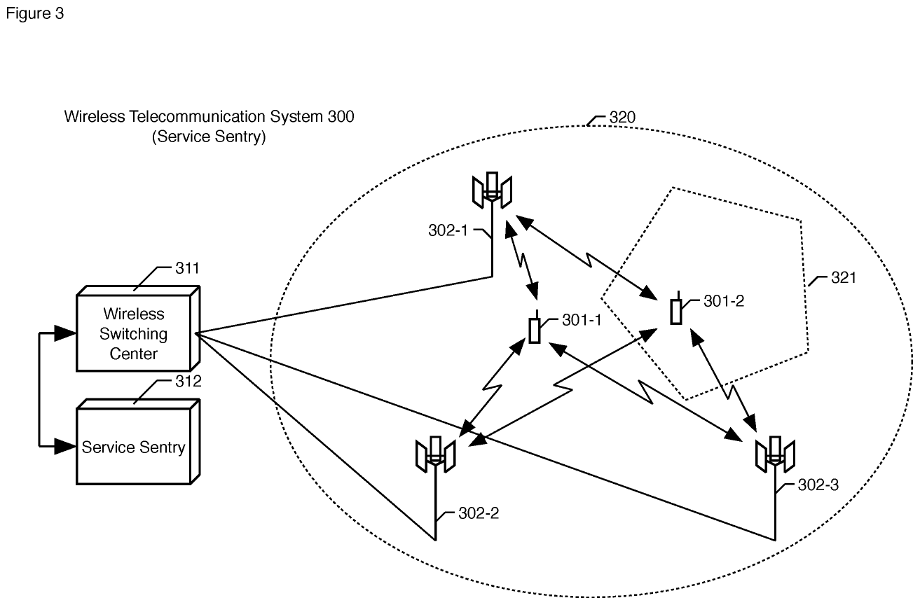

Overview— FIG. 3 depicts a diagram of the salient components of wireless telecommunications system 300 in accordance with the illustrative embodiment of the present invention. Wireless telecommunications system 300 comprises: wireless terminals 301-1 and 301-2, cellular base stations 302-1, 302-2, and 302-3, wireless switching center 311, service sentry 312, service area 320, and proscribed area 321, as shown.

Wireless telecommunications system 300:
(i) provides wireless telecommunications service to wireless terminal 301-j, where j∈{1,2}, when wireless terminal 301-j is inside of service area 320 but outside of proscribed area 321, and
(ii) selectively provides or denies wireless telecommunications service to wireless terminal 301-j—depending on the criteria described below and in the accompanying figures—when wireless terminal 301-j is within proscribed area 321.

In accordance with the illustrative embodiment, wireless switching center 311 and cellular base stations 302-1, 302-2, and 302-3 provide wireless telecommunications service to wireless terminal 301-j in accordance with the air-interface standard of the 3^{rd} Generation Partnership Project (“3GPP”). After reading this disclosure, however, it will be clear to those skilled in the art how to make and use alternative embodiments of the present invention that operate in accordance with one or more other air-interface standards (e.g., Global System Mobile “GSM,” 5G, UMTS, CDMA-2000, IS-136 TDMA, IS-95 CDMA, 3G Wideband CDMA, IEEE 802.11 WiFi, 802.16 WiMax, Bluetooth, etc.) in one or more frequency bands.

Wireless terminal 301-1 and wireless terminal 301-2 are identical and each comprises the hardware and software necessary to be 3GPP-compliant and to perform the processes described below and in the accompanying figures. For example and without limitation wireless terminal 301-j is capable of:
(a) with respect to one or more electromagnetic signals transmitted by cellular base stations 302-1, 302-2, and 302-3:
   (i) receiving those signals, and
   (ii) measuring one or more location-dependent traits of each of those signals, and
   (iii) transmitting the measurements of the location-dependent traits to service sentry 312; and
(b) with respect to one or more electromagnetic signals transmitted by wireless local area networks (e.g., 802.11 WiFi networks, etc.) in the vicinity of wireless terminal 301-j:
   (i) receiving those signals, and
   (ii) identifying each of those networks, and
   (iii) transmitting the identity of those networks to service sentry 312; and
(c) with respect to one or more electromagnetic ranging signals transmitted by satellite-positioning systems (e.g., GPS, GLONASS, etc.):
   (i) receiving those ranging signals, and
   (ii) determining its location based on those ranging signals, and
   (iii) transmitting the location to service sentry 312.

Wireless terminal 301-j is mobile and can be at any location at any time. When wireless terminal 301-j is outside of service area 320, it is not provided wireless telecommunications service by wireless telecommunications system 300. The question of whether wireless terminal 301-j is or is not provided telecommunications service by another system (not shown in FIG. 3) when it is outside of service area 320 is beyond the scope of this disclosure.

Although wireless telecommunications system 300 comprises only two wireless terminals, it will be clear to those skilled in the art, after reading this disclosure, how to make and use alternative embodiments of the present invention that comprise any number of wireless terminals.

The “home” network of wireless terminal 301-1 is wireless switching center 311, and, therefore, wireless terminal 301-1 is a “native user” of wireless switching center 311. In contrast, the home network of wireless terminal 301-2 is not wireless switching center 311; wireless terminal 301-2 has “roamed” into service area 320, and, therefore, is a “non-native” user of wireless switching center 311.

As will be clear to those skilled in the art, there are many kinds of wireless terminals (e.g., “cell phones,” IoT devices, wireless computers, wireless modems, etc.).

Cellular base stations 302-1, 302-2, and 302-3 communicate with wireless switching center 311 via wireline and with wireless terminal 301-j via radio in well-known fashion. As is well known to those skilled in the art, base stations are also commonly referred to by a variety of alternative names such as access points, nodes, network interfaces, etc. Although the illustrative embodiment comprises three base stations, it will be clear to those skilled in the art, after reading this disclosure, how to make and use alternative embodiments of the present invention that comprise any number of base stations.

In accordance with the illustrative embodiment of the present invention, cellular base stations 302-1, 302-2, and 302-3 are terrestrial, immobile, and physically within service area 320. It will be clear to those skilled in the art, after reading this disclosure, how to make and use alternative embodiments of the present invention in which some or all of the base stations are airborne, marine-based, or space-based, regardless of whether or not they are moving relative to the Earth's surface, and regardless of whether or not they are physically within service area 320.

Cellular base stations 302-1, 302-2, and 302-3 comprise the hardware and software necessary to be 3GPP-compliant and to perform the processes described below and in the accompanying figures. For example and without limitation cellular base stations 302-1, 302-2, and 302-3 are capable of:
a. measuring one or more location-dependent traits of each of one of more electromagnetic signals (transmitted by wireless terminal 301-j) and of transmitting the measurements to service sentry 312, and
b. transmitting one or more signals and of transmitting the transmission parameters of those signals to service sentry 312.

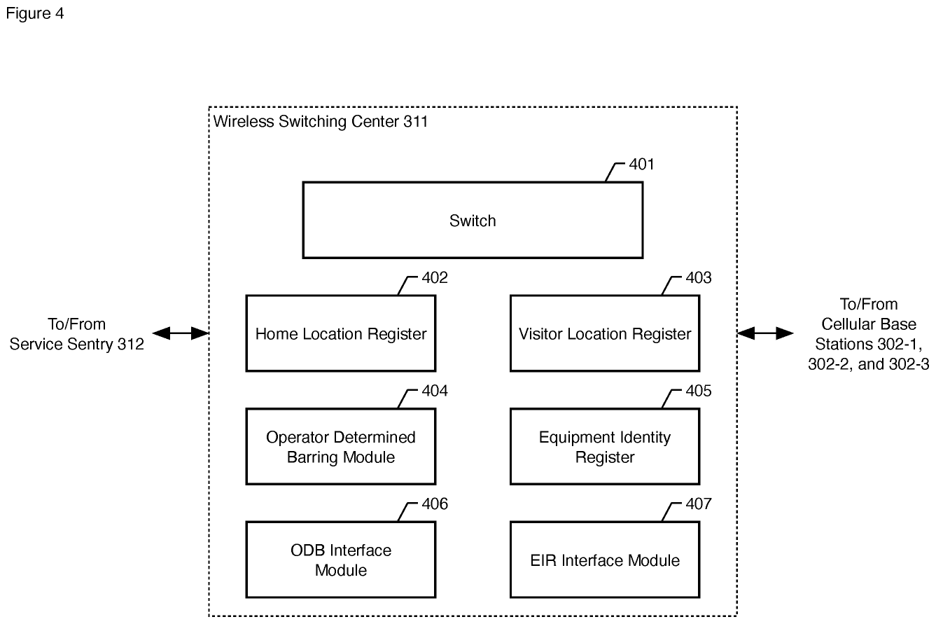

FIG. 4 depicts a schematic diagram of the salient components of wireless switching center 311, which orchestrates the operation of wireless telecommunications system 300. Wireless switching center 311 comprises switch 401, home location register 402, visitor location register 403, operator determined barring module 404, equipment identity register 405, ODB interface module 406, and EIR interface module 407.

Switch 401 provides telecommunications routing in well-known fashion. It will be clear to those skilled in the art how to make and use switch 401.

Home location register 402 is a database that contains data for those wireless terminals that have wireless switching center 311 as their home system. In accordance with the illustrative embodiment, wireless switching center 311 is the home of wireless terminal 301-1, and, therefore, home location register 402 contains a record for wireless terminal 301-1. (For the reason explained below, home location register 402 does not contain a record of wireless terminal 301-2.) It will be clear to those skilled in the art how to make and use home location register 402.

Visitor location register 403 is a database that contains data for those wireless terminals that do not have wireless switching center 311 as their home but have roamed into service area 320. In accordance with the illustrative embodiment, wireless switching center 311 is not the home of wireless terminal 301-2, and, therefore, visitor location register 403 contains a record for wireless terminal 301-2. (For the reason explained above, visitor location register 403 does not contain a record of wireless terminal 301-1.) It will be clear to those skilled in the art how to make and use visitor location register 403.

Operator determined barring module 404 is a database that contains a list of the wireless terminals that that are to be denied service by wireless switching center 311. Only those wireless terminals that are listed in home location register 402 (e.g., wireless terminal 301-1, etc.) can be listed in operator determined barring module 404.

Operator determined barring module 404 is capable of receiving, in well-known fashion, a request to add a specific wireless terminal (e.g., wireless terminal 301-1, etc.) to the list, which causes telecommunications service to that wireless terminal to be stopped. A request to stop service can be initiated within wireless switching center 311, as in the prior art, or, alternatively, a request can be initiated from outside of wireless switching center 311 by service sentry 312 and received via ODB interface module 406. As is well-known to those skilled in the art, a request to add a specific wireless terminal to the list in operator determined barring module 404 is known as “blocking” the wireless terminal.

Conversely, operator determined barring module 404 is capable of receiving, in well-known fashion, a request to remove a specific wireless terminal (e.g., wireless terminal 301-1, etc.) from the list, which causes telecommunications service to that wireless terminal to be provided (and possibly restored if it was previously provided). A request to discontinue denying (i.e., restore) service can be initiated within wireless switching center 311, as in the prior art, or, alternatively, a request can be initiated from outside of wireless switching center 311 by service sentry 312 and received via ODB interface module 406. As is well-known to those skilled in the art, a request to remove a specific wireless terminal from the list in operator determined barring module 404 is known as “un-blocking” the wireless terminal. It will be clear to those skilled in the art how to make and use operator determined barring module 404.

Equipment identity register 405 is a database that contains a list of wireless terminals that are to be denied service by wireless switching center 311. Only wireless terminals that are listed in visitor location register 403 (e.g., wireless terminal 301-2, etc.) can be listed in equipment identity register 405.

Equipment identity register 405 is capable of receiving, in well-known fashion, a request to add a specific wireless terminal (e.g., wireless terminal 301-2, etc.) to the list, which causes telecommunications service to that wireless terminal to be stopped. A request to stop service can be initiated within wireless switching center 311, as in the prior art, or, alternatively, a request can be initiated from outside of wireless switching center 311 by service sentry 312 and received via EIR interface module 407. As is well-known to those skilled in the art, a request to add a specific wireless terminal to the list in equipment identity register 405 is known as “blacklisting” the wireless terminal.

Conversely, equipment identity register 405 is capable of receiving, in well-known fashion, a request to remove a specific wireless terminal, which causes telecommunications service to that wireless terminal to be provided. A request to discontinue denying (i.e., restore) service can be initiated within wireless switching center 311, as in the prior art, or alternatively, a request can be initiated from outside of wireless switching center 311 by service sentry 312 and received via EIR interface module 407. As is well-known to those skilled in the art, a request to remove a specific wireless terminal from the list in equipment identity register 405 is known as “un-blacklisting” the wireless terminal. It will be clear to those skilled in the art how to make and use equipment identity register 405.

ODB interface module 406 is software that provides an application programming interface (“API”) to operator determined barring module 404 by an entity outside of wireless switching center 311 (e.g., service sentry 312, etc.) to request that a specific wireless terminal be added or removed from the list in operator determined barring module 404. It will be clear to those skilled in the art, after reading this specification, how to make and use ODB interface module 406.

EIR interface module 407 is software that provides an application programming interface (“API”) to equipment identity register 405 by an entity outside of wireless switching center 311 (e.g., service sentry 312, etc.) to request that a specific wireless terminal be added or removed from the list in equipment identity register 405. It will be clear to those skilled in the art, after reading this specification, how to make and use EIR interface module 407.

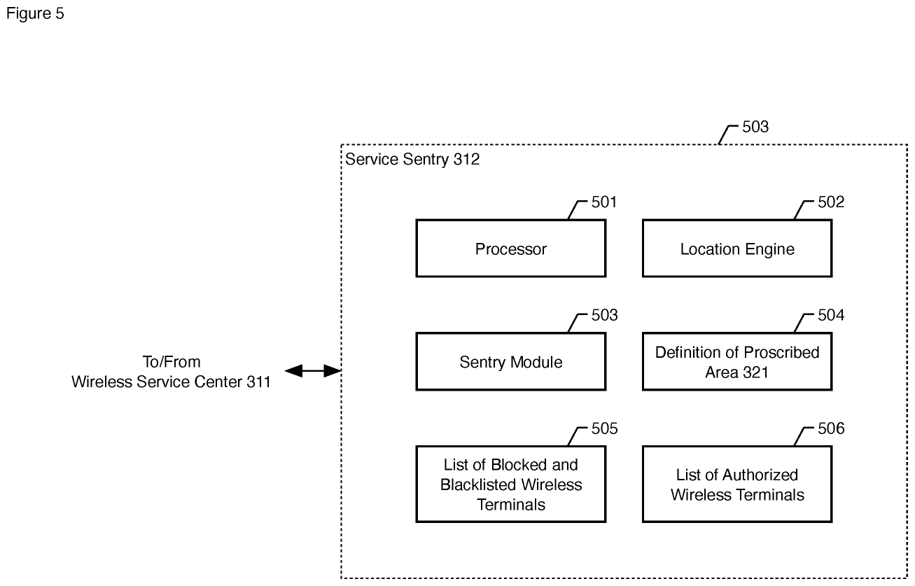

FIG. 5 depicts a schematic diagram of the salient components of service sentry 312, which:
(i) determines when and if to request that service be denied to wireless terminal 301-j, and
(ii) orchestrates the process for requesting that service be denied to wireless terminal 301-j, and
(iii) determines when and if to request that service be provided (e.g., restored) to wireless terminal 301-j, and
(iv) orchestrates the process for requesting that service be provided to wireless terminal 301-j.
   In general, service sentry 312 comprises hardware and software that is capable of performing the processes described below and in the accompanying figures. In accordance with the illustrative embodiment, service sentry 312 comprises processor 501, location engine 502, sentry module 503, definition 504 of proscribed area 321, list of blocked and blacklisted wireless terminals 505, and list of authorized wireless terminals 506.

Processor 501 is a general-purpose processor, as is well known to those skilled in the art, that executes the software in:
(i) sentry module 503, and
(ii) location engine 502, and updates:
(i) list of blocked and blacklisted wireless terminals 505, and
(ii) list of authorized wireless terminals 506 as described below and in the accompanying figures. It will be clear to those skilled in the art how to make and use processor 501.

Location engine 502 is a software module that contains the code to generate:
(i) an estimate of whether wireless terminal 301-j is inside of proscribed area 321, êₛ, and
(ii) an estimate of the confidence that êₛ is correct, ĉₛ, based on data that service sentry 312 receives from:
(i) wireless terminal 301-j, and
(ii) cellular base stations 302-1, 302-2, and 302-3, and
(iii) wireless switching center 311, which are all are evidence of the location of wireless terminal 301-j.

For the purposes of this specification, êₛ is a binary value and ĉₛ is a real number in the range 0≤ĉₛ≤1. It will be clear to those skilled in the art, after reading this disclosure, how to make and use alternative embodiments of the present invention that generate (i) the estimate of whether wireless terminal 301-j is inside of proscribed area 321, êₛ, and (ii) the estimate of the confidence that êₛ is correct, ĉₛ. Furthermore, it will be clear to those skilled in the art, after reading this disclosure, that the estimate of the confidence that êₛ is correct, ĉₛ, can be based, for example, on the statistical uncertainty of the estimate of whether wireless terminal 301-j is inside of proscribed area 321, êₛ.

The details for making and using location engine 502 are described in:
U.S. Pat. No. 6,269,246 B1 (attorney docket 0465-800 us1), and
U.S. Pat. No. 6,782,265 B2 (attorney docket 0465-001 us1), and
U.S. Pat. No. 6,944,465 B2 (attorney docket 0465-002 us1), and
U.S. Pat. No. 7,116,987 B2 (attorney docket 0465-013 us1), and
U.S. Pat. No. 7,233,799 B2 (attorney docket 0465-011 us1), and
U.S. Pat. No. 7,257,414 B2 (attorney docket 0465-038 us1), and
U.S. Pat. No. 7,383,051 B2 (attorney docket 0465-029 us1), and
U.S. Pat. No. 7,433,695 B2 (attorney docket 0465-041 us1), and
U.S. Pat. No. 7,460,505 B2 (attorney docket 0465-004 us1), and
U.S. Pat. No. 7,734,298 B2 (attorney docket 0465-051 us1), and
U.S. Pat. No. 7,753,278 B2 (attorney docket 0465-039 us1), and
U.S. Pat. No. 7,796,966 B2 (attorney docket 0465-017 us1), and
U.S. Pat. No. 7,899,467 B2 (attorney docket 0465-050 us1), and
U.S. Pat. No. 8,532,676 B1 (attorney docket 0465-303 us1), and
U.S. Pat. No. 8,630,665 B1 (attorney docket 0465-301 us1), and
U.S. Pat. No. 8,712,428 B2 (attorney docket 0465-009 us1), and
U.S. Pat. No. 8,891,393 B2 (attorney docket 0465-302 us1), and
U.S. Pat. No. 8,965,393 B2 (attorney docket 0465-035 us1), and
U.S. Pat. No. 9,165,288 B2 (attorney docket 0465-330 us1), and
U.S. Pat. No. 9,237,423 B2 (attorney docket 0465-365 us1), and
U.S. Pat. No. 9,247,516 B2 (attorney docket 0465-056 us1), and
U.S. Pat. No. 9,285,455 B2 (attorney docket 0465-322 us1), and
U.S. Pat. No. 9,332,389 B2 (attorney docket 0465-361 us1), and
U.S. Pat. No. 9,398,402 B2 (attorney docket 0465-151 us1), and
U.S. Pat. No. 9,596,571 B2 (attorney docket 0465-366 us1), and
U.S. Pat. No. 9,942,713 B1 (attorney docket 0465-403 us1), and
U.S. Pat. No. 9,967,703 B2 (attorney docket 0465-390 us1), and
U.S. Pat. No. 10,123,298 B1 (attorney docket 0465-362 us1), and
U.S. Pat. No. 10,145,935 B1 (attorney docket 0465-362 us1), and
U.S. Pat. No. 10,412,699 B1 (attorney docket 0465-427 us1), and
U.S. Pat. No. 10,715,960 B1 (attorney docket 0465-428 us1),
   each of which is incorporated by reference for the purpose of teaching how to make and use location engine 502.

Sentry module 503 is software that:
(1) requests that service to wireless terminal 301-j be denied (blocked or blacklisted, as appropriate) when:
   (i) the estimate of whether wireless terminal 301-j is inside of proscribed area 321, êₛ, indicates that wireless terminal is, in fact, inside of proscribed area 321 with greater than X confidence (i.e., ĉₛ>X), where X is a real number in the range 0≤X≤1, and
   (ii) service to wireless terminal 301-j is not being denied (blocked or blacklisted, as appropriate), and
(2) requests that service to wireless terminal 301-j be provided (un-blocked or un-blacklisted, as appropriate) when:
   (i) the estimate of whether wireless terminal 301-j is inside of proscribed area 321, êₛ, indicates that wireless terminal is, in fact, outside of proscribed area 321 with greater than Y confidence (i.e., ĉₛ>Y), where Y is a real number in the range 0≤Y≤1, and
   (ii) service to wireless terminal 301-j is being denied (blocked or blacklisted, as appropriate), and
(3) updates list of blocked and blacklisted wireless terminals 505, as appropriate.
   The processes performed by sentry module 503 are illustrated in greater detail below and in accordance with the accompanying figures.

Definition 504 of proscribed area 321 is a geometric definition of proscribed area 321. In accordance with the illustrative embodiment, proscribed area 321 is a polygon that is defined by the latitude and longitude of its vertices. It will be clear to those skilled in the art, after reading this disclosure, how to make and use alternative embodiments of the present invention in which the proscribed area is defined as any enclosed two-dimensional area or areas (e.g., circles, ellipses, squares, rectangles, polygons, irregular areas, etc.) or any three-dimensional volume or volumes (e.g., spheres, ellipsoids, cubes, boxes, polyhedral, irregular volumes, etc.).

List of blocked and blacklisted wireless terminals 505 is a list that enables service sentry 312 to keep track of which wireless terminals are currently being blocked and blacklisted. In particular, list of blocked and blacklisted wireless terminals 505 is a list of those wireless terminals that service sentry 312 has:
(i) requested operator determined barring module 404 to block, or
(ii) requested equipment identity register 405 to blacklist and that service sentry 312 has not requested be un-blocked or un-blacklisted, as appropriate. It will be clear to those skilled in the art, after reading this disclosure, how to make and use list of blocked and blacklisted wireless terminals 505.

List of authorized wireless terminals 506 is a list of those wireless terminals, if any, that are permitted to operate inside of proscribed area 321. The owner/operator of wireless telecommunications system 300 decides whether to add or remove wireless terminals to this list, and the criteria for deciding which wireless terminals are added or removed is beyond the scope of this disclosure.

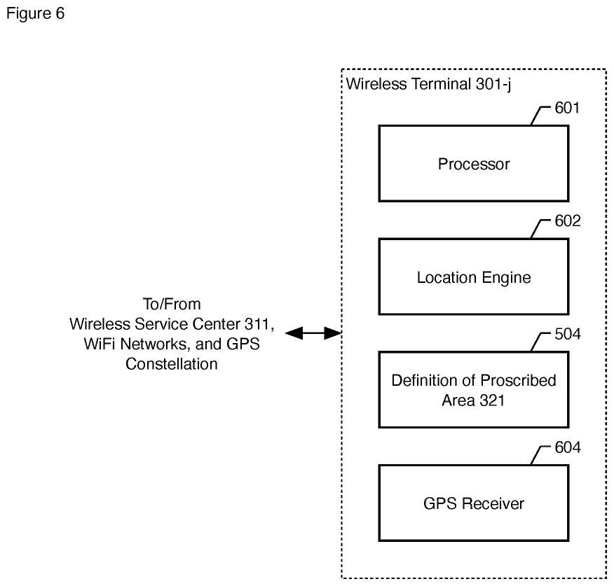

FIG. 6 depicts a schematic diagram of the salient components of wireless terminal 301-j, which assists service sentry 312 in generating the estimate of whether wireless terminal 301-j is inside of proscribed area 321, êₛ. The principal advantage of having wireless terminal 301-j assist service sentry 312 is that it generally improves the reliability of êₛ because wireless terminal 301-j has access to empirical evidence about its own location that service sentry 312 does not have and that evidence is usually highly probative.

Wireless terminal 301-j is a standard off-the-shelf smart terminal such as for example and without limitation an Apple® iPhone®, Samsung® Galaxy®, etc. Wireless terminal 301-j comprises hardware and software that is capable of performing the processes described below and in the accompanying figures. In accordance with the illustrative embodiment, wireless terminal 301-j comprises processor 601, location engine 602, definition 504 of proscribed area 321, and GPS receiver 604.

Processor 601 is a general-purpose processor, as is well known to those skilled in the art, that executes the software in location engine 602 as described below and in the accompanying figures. It will be clear to those skilled in the art how to make and use processor 601.

Location engine 602 is a software module, similar to location engine 502, that contains the code to generate:
(i) an estimate of whether wireless terminal 301-j is inside of proscribed area 321, êₛ, and
(ii) the estimate of the confidence that êₜ is correct, ĉₜ, based on:
(i) the measurements of the location-dependent traits of the electromagnetic signals transmitted by cellular base stations 302-1, 302-2, and 302-3 as received by wireless terminal 301-j, and
(ii) the identity of the wireless local area networks in the vicinity of wireless terminal 301-j, and
(iii) the estimates of the location of wireless terminal 301-j as determined by GPS receiver 604, and
(iv) definition 504 of proscribed area 321.

Note that wireless terminal 301-fs estimate of whether it is inside of proscribed area 321, êₜ, is different than service sentry 312's estimate of whether wireless terminal 301-j is inside of proscribed area 321, êₛ, because wireless terminal 301-j and service sentry 312 each base their estimates on different empirical data. For the same reason, wireless terminal 301-j 's estimate of ĉₜ is different than service sentry 312's estimate of ĉₛ.

The details for making and using location engine 602 are described in:
U.S. Pat. No. 6,269,246 B1 (attorney docket 0465-800 us1), and
U.S. Pat. No. 6,782,265 B2 (attorney docket 0465-001 us1), and
U.S. Pat. No. 6,944,465 B2 (attorney docket 0465-002 us1), and
U.S. Pat. No. 7,116,987 B2 (attorney docket 0465-013 us1), and
U.S. Pat. No. 7,233,799 B2 (attorney docket 0465-011 us1), and
U.S. Pat. No. 7,257,414 B2 (attorney docket 0465-038 us1), and
U.S. Pat. No. 7,383,051 B2 (attorney docket 0465-029 us1), and
U.S. Pat. No. 7,433,695 B2 (attorney docket 0465-041 us1), and
U.S. Pat. No. 7,460,505 B2 (attorney docket 0465-004 us1), and
U.S. Pat. No. 7,734,298 B2 (attorney docket 0465-051 us1), and
U.S. Pat. No. 7,753,278 B2 (attorney docket 0465-039 us1), and
U.S. Pat. No. 7,796,966 B2 (attorney docket 0465-017 us1), and
U.S. Pat. No. 7,899,467 B2 (attorney docket 0465-050 us1), and
U.S. Pat. No. 8,532,676 B1 (attorney docket 0465-303 us1), and
U.S. Pat. No. 8,630,665 B1 (attorney docket 0465-301 us1), and
U.S. Pat. No. 8,712,428 B2 (attorney docket 0465-009 us1), and
U.S. Pat. No. 8,891,393 B2 (attorney docket 0465-302 us1), and
U.S. Pat. No. 8,965,393 B2 (attorney docket 0465-035 us1), and
U.S. Pat. No. 9,165,288 B2 (attorney docket 0465-330 us1), and
U.S. Pat. No. 9,237,423 B2 (attorney docket 0465-365 us1), and
U.S. Pat. No. 9,247,516 B2 (attorney docket 0465-056 us1), and
U.S. Pat. No. 9,285,455 B2 (attorney docket 0465-322 us1), and
U.S. Pat. No. 9,332,389 B2 (attorney docket 0465-361 us1), and
U.S. Pat. No. 9,398,402 B2 (attorney docket 0465-151 us1), and
U.S. Pat. No. 9,596,571 B2 (attorney docket 0465-366 us1), and
U.S. Pat. No. 9,942,713 B1 (attorney docket 0465-403 us1), and
U.S. Pat. No. 9,967,703 B2 (attorney docket 0465-390 us1), and
U.S. Pat. No. 10,123,298 B1 (attorney docket 0465-362 us1), and
U.S. Pat. No. 10,145,935 B1 (attorney docket 0465-362 us1), and
U.S. Pat. No. 10,412,699 B1 (attorney docket 0465-427 us1), and
U.S. Pat. No. 10,715,960 B1 (attorney docket 0465-428 us1), each of which is incorporated by reference for the purpose of teaching how to make and use location engine 602.

Definition 504 of proscribed area 321 is the same definition of proscribed area 321 as in service sentry 312.

GPS receiver 604 is a satellite-positioning system receiver in well-known fashion, which is capable of receiving ranging signals from one or more constellations of navigation satellites (not shown in the figures) and for generating an estimate of the location of wireless terminal 301-j based on those signals.

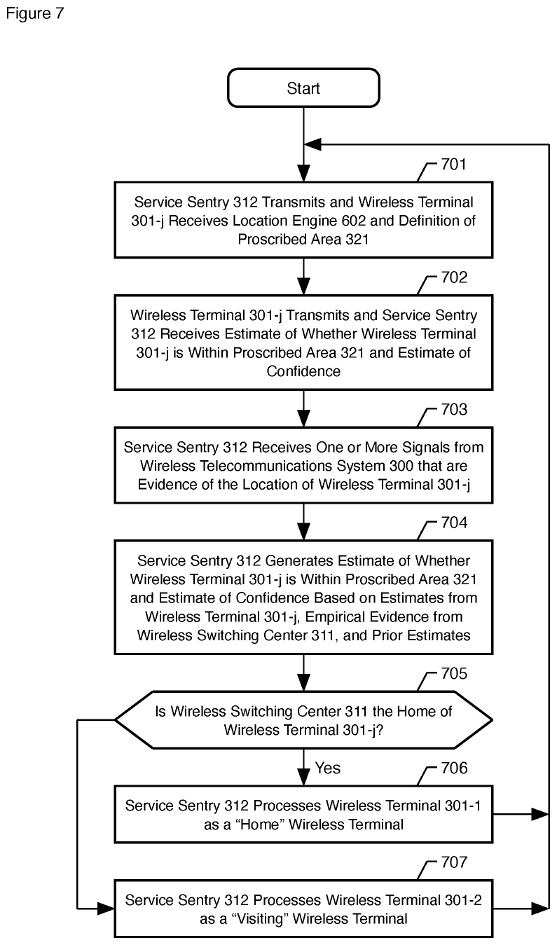

FIG. 7 depicts a flowchart of the operation of the illustrative embodiment of the present invention as performed by service sentry 312.

At task 701, service sentry 312 transmits and wireless terminal 301-j receives:
(i) location engine 602, and
(ii) definition 504 of proscribed area 321.
   On the initial execution of task 701, location engine 602 and definition 504 of proscribed area 321 are transmitted in full. On subsequent executions of task 701, updates to location engine 602 and definition 504, if any and as needed, are transmitted to wireless terminal 301-j.

At task 702, wireless terminal 301-j transmits and service sentry 312 receives:
(i) an estimate of whether wireless terminal 301-j is inside of proscribed area 321, êₜ, and
(ii) an estimate of the confidence that êₜ is correct, ĉₜ.
   With each execution of task 702, wireless terminal 301-j transmits an updated estimate of êₜ and ĉₜ based on the most recent empirical data available to it.

Although wireless terminal 301-j is capable of transmitting to service sentry 312:
(i) the raw empirical measurements that it receives that are probative of its location (e.g., the measurements of the location-dependent traits of the signals transmitted by cellular base stations 302-1, 302-2, and 302-3, the identity of those wireless local area networks in its vicinity, the satellite positioning system ranging data, etc.), and
(ii) its own estimate of its exact location,
   wireless terminal 301-j does not in order to protect the privacy of the user of wireless terminal 301-j. It will be clear to those skilled in the art, after reading this disclosure, how to make and use alternative embodiments of the present invention in which a wireless terminal does transmit this information.

It will be clear to those skilled in the art, after reading this disclosure, how to enable service sentry 312 to perform task 702.

At task 703, service sentry 312 receives one or more signals from wireless switching center 311 that are evidence of the location of wireless terminal 301-j. Sometimes the signals are provided to service sentry 312 by wireless switching center 311 in response to a request by service sentry 312 for those signals (e.g., a request for an Mobile Terminated Location Request to verify the distance from wireless terminal 301-j to proscribed area 321 as received in task 702, etc.), and sometimes the signals are provided by wireless switching center 311 of its own accord (i.e., spontaneously) in response to a network event (e.g., wireless terminal 301-j crossing a cell boundary, etc.). It will be clear to those skilled in the art, after reading this disclosure, how to enable service sentry 312 to perform task 703.

At task 704, service sentry 312 uses location engine 502 to generate:
(i) its own estimate of whether wireless terminal 301-j is inside of proscribed area 321, êₛ, and
(ii) its own estimate of the confidence that êₛ is correct, ĉₛ, based on:
(i) the estimate of whether wireless terminal 301-j is inside of proscribed area 321, êₜ, as received from wireless terminal 301-1, and
(ii) the estimate of the confidence that eₜ is correct, eₜ, as received from wireless terminal 301-1, and
(iii) the empirical evidence of the location of wireless terminal 301-j, as received from wireless switching center 311, and
(iv) prior estimates of the location of wireless terminal 301-j.
   It will be clear to those skilled in the art, after reading this disclosure, how to make and use alternative embodiments of the present invention that generate estimates of êₛ and ĉₛ based on any sub-combination of i, ii, iii, and iv. It will be clear to those skilled in the art, after reading this disclosure, how to enable service sentry 312 to perform task 704.

At task 705, service sentry 312 bifurcates the processing for those wireless terminals whose home is wireless switching center 311 from those who have roamed into service area 320. Control for those wireless terminals (e.g., wireless terminal 301-1, etc.) whose home is wireless switching center 311 proceeds to task 706. In contrast, control for those wireless terminals (e.g., wireless terminal 301-2, etc.) who are roaming proceeds to task 707. It will be clear to those skilled in the art, after reading this disclosure, how to enable service sentry 312 to perform task 705.

At task 706, service sentry 312 processes wireless terminal 301-1 as a “home” wireless terminal. Task 706 is described in detail below and in the accompanying figure. After task 706 has been completed, control returns to task 701.

At task 707, service sentry 312 processes wireless terminal 301-2 as a “visiting” wireless terminal. Task 707 is described in detail below and in the accompanying figure. After task 707 has been completed, control returns to task 701.

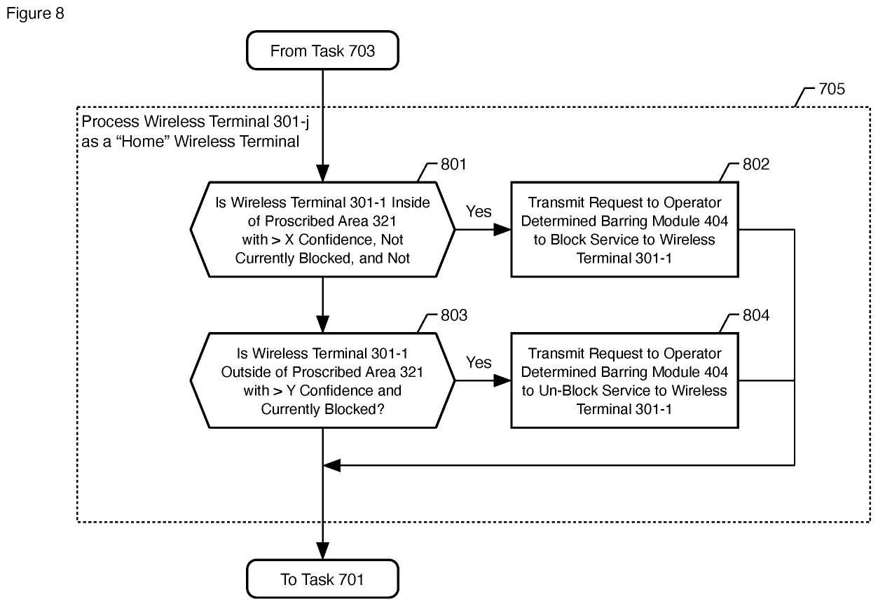

FIG. 8 depicts a flowchart of the salient subtasks associated with the performance of task 706—processing wireless terminal 301-1 as a “home” (i.e., not “roaming”) wireless terminal of wireless switching center 311.

At task 801, service sentry 312 uses the software and data in sentry module 503 to determine:
(i) does the estimate êₛ indicate that wireless terminal 301-1 is inside of proscribed area, and
(ii) does the estimate ĉₛ equal or exceed X, and
(iii) is service to wireless terminal 301-1 currently blocked by operator determined barring module 404, and
(iv) is wireless terminal 301-1 listed in list of authorized wireless terminals 506?
   If the answer to (i) & (ii) is “Yes” and (iii) & (iv) is “No,” then control passes to task 802—to block service to wireless terminal 301-1; otherwise, control passes to task 803.

In accordance with the illustrative embodiment, X=0.85, but it will be clear to those skilled in the art, after reading this disclosure, how to make and use alternative embodiments of the present invention in which X has another value.

In accordance with the illustrative embodiment, service sentry 312 determines whether service to wireless terminal 301-1 is currently blocked by operator determined barring module 404 by querying list of blocked and blacklisted wireless terminals 505.

It will be clear to those skilled in the art, after reading this disclosure, how to enable service sentry 312 to perform task 801.

At task 802, service sentry 312 uses the software and data in sentry module 503 to transmit a request to operator determined barring module 404—via ODB interface module 406—to block wireless terminal 301-1, which has the effect of causing wireless switching center 311 to deny service to wireless terminal 301-1. As part of task 802, service sentry 312 adds wireless terminal 301-1 to list of blocked and blacklisted wireless terminals 505.

It will be clear to those skilled in the art, after reading this disclosure, how to enable service sentry 312 to perform task 802.

At task 803, service sentry 312 uses the software and data in sentry module 503 to determine:
(i) does the estimate êₛ indicate that wireless terminal 301-1 is outside of proscribed area, and
(ii) does the estimate ĉₛ equal or exceed Y, and
(iii) is service to wireless terminal 301-1 currently blocked by operator determined barring module 404, and
   If the answer to (i), (ii), and (iii) are “Yes,” then control passes to task 804; otherwise, control passes to task 701.

In accordance with the illustrative embodiment, Y=0.95, but it will be clear to those skilled in the art, after reading this disclosure, how to make and use alternative embodiments of the present invention in which Y has another value.

When wireless terminal 301-1 is near the boundary of proscribed area 321, the estimate êₛ can be wrong. Furthermore, successive estimates of êₛ can fluctuate, and this particularly true when wireless terminal 301-1 is moving parallel to the boundary. Without more, this would cause service sentry 312 to thrash blocking and unblocking service to wireless terminal 301-1, which could be perceived as irritating to the user of wireless terminal 301-1. To prevent this from happening, the values of X and Y are high (e.g., X, Y>0.80, etc.).

Furthermore, the estimate êₛ can be wrong in two different ways:
(1) Type I Error—the estimate êₛ indicates that wireless terminal 301-1 is outside of proscribed area 321 when, in fact, it is inside of proscribed area 321, and
(2) Type II Error—the estimate êₛ indicates that wireless terminal 301-1 is inside of proscribed area 321 when, in fact, it is outside of proscribed area 321.
   In accordance with the illustrative embodiment, a Type I Error is considered more problematic than a Type II Error. In other words, it is better to block or blacklist, as appropriate, a wireless terminal that is outside of proscribed area 321 than it is to fail to block or blacklist a wireless terminal that is inside of proscribed area 321. To accomplish this, the values of X and Y are established so that Y>X. It will be clear to those skilled in the art, after reading this disclosure, how to make and use alternative embodiments of the present invention in which a Type I Error is considered less problematic than a Type II Error, and, therefore, that Y<X. Furthermore, it will be clear to those skilled in the art, after reading this disclosure, how to make and use alternative embodiments of the present invention in which Type I Errors and Type II Errors are equally problematic, and, therefore, that Y=X.

In accordance with the illustrative embodiment, service sentry 312 determines whether service to wireless terminal 301-1 is currently blocked by operator determined barring module 404 by querying list of blocked and blacklisted wireless terminals 505.

It will be clear to those skilled in the art, after reading this disclosure, how to enable service sentry 312 to perform task 803.

At task 804, service sentry 312 uses the software and data in sentry module 503 to transmit a request to operator determined barring module 404—via ODB interface module 406—to un-block wireless terminal 301-1, which would have the effect of causing wireless switching center 311 to discontinue denying (i.e., restore) service to wireless terminal 301-1. As part of task 804, service sentry 312 removes wireless terminal 301-1 from list of blocked and blacklisted wireless terminals 505.

It will be clear to those skilled in the art, after reading this disclosure, how to enable service sentry 312 to perform task 804.

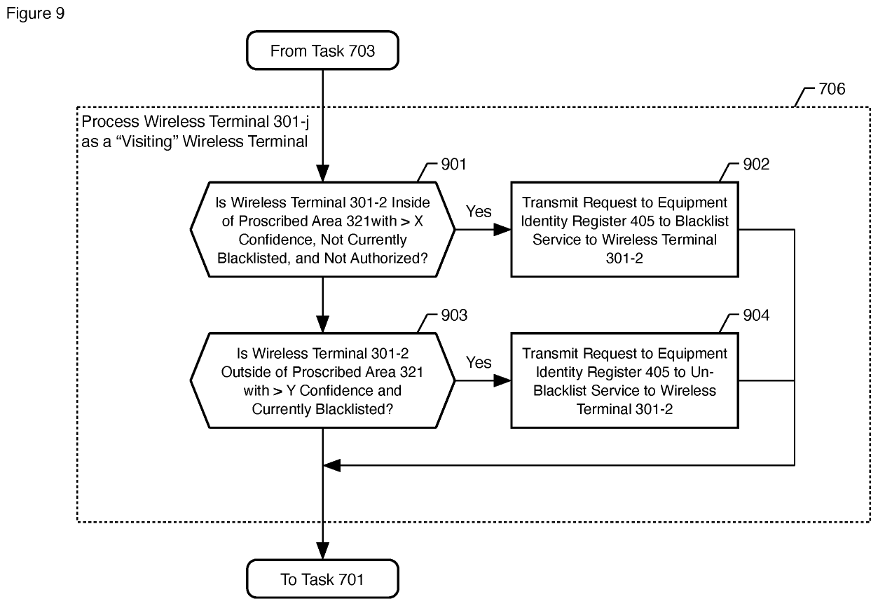

FIG. 9 depicts a flowchart of the salient subtasks associated with the performance of task 707—processing wireless terminal 301-2 as a “visiting” (i.e., “roaming”) wireless terminal of wireless switching center 311.

At task 901, service sentry 312 uses the software and data in sentry module 503 to determine:
(i) does the estimate êₛ indicate that wireless terminal 301-1 is inside of proscribed area, and
(ii) does the estimate ĉₛ equal or exceed X, and
(iii) is wireless terminal 301-2 currently blacklisted by equipment identity register 406, and
(iv) is wireless terminal 301-2 listed in list of authorized wireless terminals 506?
   If the answer to (i) & (ii) is “Yes” and (iii) & (iv) is “No,” then control passes to task 902; otherwise, control passes to task 903.

In accordance with the illustrative embodiment, service sentry 312 determines whether service to wireless terminal 301-2 is currently blacklisted by equipment identity register 406 by querying list of blacklisted and blacklisted wireless terminals 505.

It will be clear to those skilled in the art, after reading this disclosure, how to enable service sentry 312 to perform task 901.

At task 902, service sentry 312 uses the software and data in sentry module 503 to transmit a request to equipment identity register 406—via EIR interface module 407—to blacklist wireless terminal 301-2, which has the effect of causing wireless switching center 311 to deny service to wireless terminal 301-2. As part of task 902, service sentry 312 adds wireless terminal 301-2 to list of blocked and blacklisted wireless terminals 505.

It will be clear to those skilled in the art, after reading this disclosure, how to enable service sentry 312 to perform task 902.

At task 903, service sentry 312 uses the software and data in sentry module 503 to determine:
(i) does the estimate êₛ indicate that wireless terminal 301-1 is outside of proscribed area, and
(ii) does the estimate ĉₛ equal or exceed Y, and
(iii) is wireless terminal 301-2 currently blacklisted by equipment identity register 406?
   If the answer to (i), (ii), and (iii) are “Yes,” then control passes to task 904; otherwise, control passes to task 701.

In accordance with the illustrative embodiment, service sentry 312 determines whether service to wireless terminal 301-2 is currently blacklisted by equipment identity register 406 by querying list of blacklisted and blacklisted wireless terminals 505.

It will be clear to those skilled in the art, after reading this disclosure, how to enable service sentry 312 to perform task 903.

At task 904, service sentry 312 uses the software and data in sentry module 503 to transmit a request to equipment identity register 406—via EIR interface module 407—to un-blacklist wireless terminal 301-2, which would have the effect of causing wireless switching center 311 to discontinue denying (i.e., restore) service to wireless terminal 301-2. As part of task 904, service sentry 312 removes wireless terminal 301-2 from list of blocked and blacklisted wireless terminals 505.

It will be clear to those skilled in the art, after reading this disclosure, how to enable service sentry 312 to perform task 904.

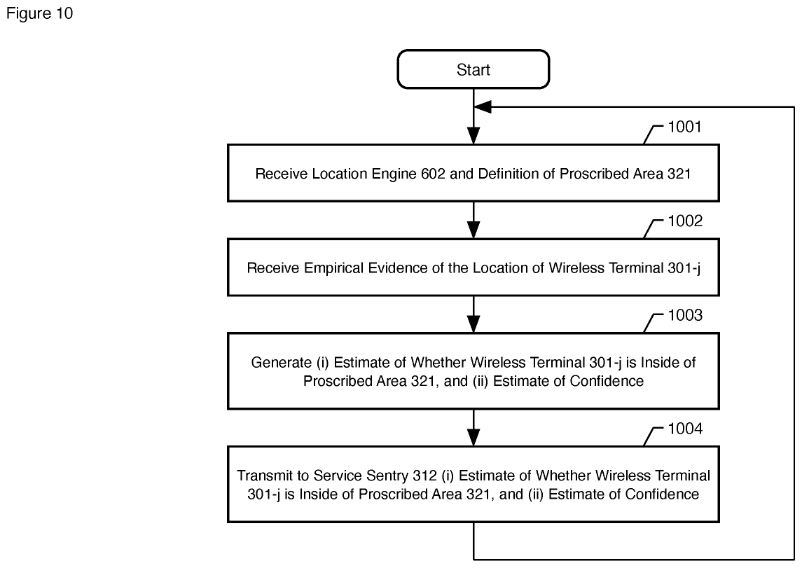

FIG. 10 depicts a flowchart of the salient tasks performed by wireless terminal 301-j in accordance with the illustrative embodiment.

At task 1001, wireless terminal 301-j receives:
(i) location engine 602, which is an “app” for wireless terminal 301-j, and
(ii) definition 504 of proscribed area 321 from service sentry 312. It will be clear to those skilled in the art, after reading this disclosure, how to enable wireless terminal 301-j to perform task 1001.

At task 1002, wireless terminal 301-j gathers empirical evidence of its location. In particular, wireless terminal 301-j receives:
(i) one or more electromagnetic signals transmitted by cellular base stations 302-1, 302-2, and 302-3, and
(ii) one or more electromagnetic signals transmitted by wireless local area networks in the vicinity of wireless terminal 301-j, and
(iii) one or more ranging signals transmitted by the satellites in a satellite-positioning system constellation.
   It will be clear to those skilled in the art, after reading this disclosure, how to make and use alternative embodiments of the present invention in which task 1002 receives any sub-combination of i, ii, and iii. In every case, it will be clear to those skilled in the art, after reading this disclosure, how enable wireless terminal 301-j to perform task 1002.

At task 1003, wireless terminal 301-j uses location engine 602 and definition 504 of proscribed area 321 to generate:
(i) its own estimate of whether wireless terminal 301-j is inside of proscribed area 321, êₜ, and
(ii) its own estimate of the confidence that êₜ is correct, ĉₜ, based on:
(i) the measurements of the location-dependent traits of the electromagnetic signals transmitted by cellular base stations 302-1, 302-2, and 302-3 as received by wireless terminal 301-j, and
(ii) the identity of the wireless local area networks in the vicinity of wireless terminal 301-j, and
(iii) the estimates of the location of wireless terminal 301-j as determined by GPS receiver 604, and
(iv) definition 504 of proscribed area 321.
   It will be clear to those skilled in the art, after reading this disclosure, how enable wireless terminal 301-j to perform task 1003.

At task 1004, wireless terminal 301-j transmits:
(i) the estimate of whether wireless terminal 301-j is inside of proscribed area 321, êₜ, and
(ii) the estimate of the confidence that êₜ is correct, ĉₜ, generated in task 1003 to service sentry 312 via:
(i) wireless telecommunications network 300, or
(ii) the Internet via a wireless local area network (e.g., 802.11 WiFi connection, etc.), or
(iii) both i and ii.
   It will be clear to those skilled in the art, after reading this disclosure, how enable wireless terminal 301-j to perform task 1004.

What is claimed is:

1. A method comprising:
transmitting, to a wireless terminal, a definition of a proscribed area, wherein:
(i) the wireless terminal is a native user of a wireless switching center, and
(ii) the wireless terminal is being provided telecommunications service by a wireless telecommunications system that comprises the wireless switching center;
receiving, from the wireless terminal, a first estimate of whether the wireless terminal is inside of the proscribed area at a first time; and
transmitting, to an operator determined barring module associated with the wireless switching center, a request to block service to the wireless terminal when the first estimate is that the wireless terminal is inside of the proscribed area.

2. The method of claim 1 further comprising:
receiving, from the wireless terminal, a second estimate of whether the wireless terminal is inside of the proscribed area at a second time; and
transmitting, to the operator determined barring module, a request to un-block service to the wireless terminal when the second estimate is that the wireless terminal is outside of the proscribed area.

3. The method of claim 1 wherein the first time is before the second time.

4. The method of claim 1 wherein the second time is before the first time.

5. The method of claim 1 wherein the wireless terminal is absent from a list of wireless terminals authorized to operate inside of the proscribed area.

6. A method comprising:
transmitting, to a wireless terminal, a definition of a proscribed area, wherein:
(i) the wireless terminal is a native user of a wireless switching center, and
(ii) an operator determined barring module associated with the wireless switching center is blocking service to the wireless terminal;
receiving, from the wireless terminal, an estimate of whether the wireless terminal is inside of the proscribed area; and
transmitting, to the operator determined barring module, a request to un-block service to the wireless terminal when the estimate is that the wireless terminal is outside of the proscribed area.

7. A method comprising:
receiving a first signal that is evidence of the location of a wireless terminal at a first time, wherein:
(i) the wireless terminal is a native user of a wireless switching center, and
(ii) the wireless terminal is being provided telecommunications service by a wireless telecommunications system that comprises the wireless switching center;
generating, based on the first signal, a first estimate of whether the wireless terminal is inside of a proscribed area at the first time;
transmitting, to an operator determined barring module associated with the wireless switching center, a request to block service to the wireless terminal when the first estimate is that the wireless terminal is inside of the proscribed area;
transmitting a definition of the proscribed area to the wireless terminal;
receiving, from the wireless terminal, a second estimate of whether the wireless terminal is inside of the proscribed area at a second time; and
transmitting, to the operator determined barring module associated with the wireless switching center, a request to un-block service to the wireless terminal when the second estimate is that the wireless terminal is outside of the proscribed area;
wherein the first time is before the second time.

8. A method comprising:
receiving a first signal that is evidence of the location of a wireless terminal at a first time, wherein:
(i) the wireless terminal is a native user of a wireless switching center, and
(ii) the wireless terminal is being provided telecommunications service by a wireless telecommunications system that comprises the wireless switching center;
generating, based on the first signal, a first estimate of whether the wireless terminal is inside of a proscribed area at the first time;
transmitting, to an operator determined barring module associated with the wireless switching center, a request to un-block service to the wireless terminal when the first estimate is that the wireless terminal is outside of the proscribed area;
transmitting a definition of the proscribed area to the wireless terminal;
receiving, from the wireless terminal, a second estimate of whether the wireless terminal is inside of the proscribed area at a second time; and
transmitting, to the operator determined barring module associated with the wireless switching center, a request to block service to the wireless terminal when the second estimate is that the wireless terminal is inside of the proscribed area;
wherein the first time is before the second time.
